(19) United States
(12) Patent Application Publication
(10) Pub. No.: US 2016/0248707 A1
(43) Pub. Date: Aug. 25, 2016

(54) REAL-TIME INTER-PERSONAL COMMUNICATION

(71) Applicant: HEWLETT PACKARD ENTERPRISE DEVELOPMENT LP, Houston, TX (US)

(72) Inventors: Kieran McCorry, Belfast (GB); David Banthorpe, Reading (GB)

(21) Appl. No.: 15/031,006

(22) PCT Filed: Oct. 24, 2013
(86) PCT No.: PCT/US2013/066616

§ 371 Date: Apr. 21, 2016

(51) Int. Cl. H04L 12/58

(52) U.S. Cl. CPC H04L 51/04; H04L 51/36

(57) ABSTRACT

A real-time inter-personal communication includes obtaining user preferences for an inter-personal communication for an initiator and a recipient, receiving an environmental context for the initiator and the recipient, and determining an optimal mode or inter-personal communication in real-time between the initiator and the recipient based on a correlation of the user preferences and the environmental context.

### BACKGROUND

Inter-personal communications include an exchange of communications between individuals. Often, the inter-personal communications may take place between the individuals using devices such as smart phones, computers, or other devices. Further, the individuals communicate with each other, on such devices, by using a variety of modes of inter-personal communication such as audio conferencing, video conferencing, instant messaging, text messaging, electronic mail (email), or other modes of inter-personal communication.

### BRIEF DESCRIPTION OF THE DRAWINGS

The accompanying drawings illustrate various examples of the principles described herein and are a part of the specification. The examples do not limit the scope of the claims.

FIG. 1 is a diagram of an example of a system for optimizing a real-time inter-personal communication, according to the principles described herein.

FIG. 2 is a diagram of an example of an optimizing system, according to the principles described herein.

FIG. 3 is a flowchart of an example of a method for optimizing a real-time inter-personal communication, according to one example of principles described herein.

FIG. 4 is a flowchart of an example of a method for optimizing a real-time inter-personal communication, according to one example of principles described herein.

FIG. 5 is a diagram of an example of an optimizing system, according to the principles described herein.

FIG. 6 is a diagram of an example of an optimizing system, according to the principles described herein.

Throughout the drawings, identical reference numbers designate similar, but not necessarily identical, elements.

### DETAILED DESCRIPTION

Often, an initiator of an inter-personal communication may have a number of different options for the mode of inter-personal communication to employ with a recipient. Further, with no many different forms of inter-personal communication available, the initiator of an inter-personal communication selects a convenient mode for the inter-personal communication according to what the initiator determines is a convenient mode. For example, the initiator may review an online status of the recipient across multiple communications systems to determine the most convenient mode of inter-personal communication to select, taking into account the recipient's current online status.

However, such status information for the recipient may not always be available to the initiator. As a result, the initiator may not be able to determine the most convenient mode of inter-personal communication. Further, the mode of inter-personal communication that the initiator selects may be inconvenient for the recipient of inter-personal communication.

The principles described herein include a method for optimizing a real-time inter-personal communication. Such a method includes obtaining user preferences for an inter-personal communication for an initiator and a recipient, receiving an environmental context for the initiator and the recipient, and determining an optimal mode of inter-personal communication in real-time between the initiator and the recipient based on a correlation of the user preferences and the environmental context. Such a method allows communication between the initiator and the recipient of inter-personal communications to reflect individual preferences and the environmental context of the initiator and the recipient such that the mode of inter-personal communication is optimal for both the initiator and the recipient. As a result, a mutually convenient mode of inter-personal communication is employed which is optimized for both the initiator and the recipient.

Further, the method can include modifying the optimal mode of the inter-personal communication in real-time if the optimal mode becomes undesirable during the inter-personal communication. Modifying the optimal mode of the inter-personal communication in real-time if the optimal mode becomes undesirable during the inter-personal communication will be described in more detail below.

In the present specification and in the appended claims, the term “mode” is meant to be understood broadly as a form of inter-personal communication between an initiator and a recipient. In one example, a mode may be a text based mode, an audio based mode, a video based mode, other modes, or combinations thereof.

In the present specification and in the appended claims, the term “initiator” is meant to be understood broadly as an individual who commences the inter-personal communication. In the present specification and in the appended claims, the term “recipient” is meant to be understood broadly as an individual who receives the inter-personal communication from the initiator.

In the present specification and in the appended claims, the term “environmental context” is meant to be understood broadly as the physical environment that the initiator, the recipient, or combinations thereof may be in. In one example, the environmental context includes networks, services, and modes of inter-personal communication available to the recipient and the initiator at a specific time, a location of the recipient and the initiator, or combinations thereof.

Still further, as used in the present specification and in the appended claims, the term “real-time” is meant to be understood broadly as the processing of information that returns a result so rapidly that the inter-personal communication appears to be instantaneous. For example, an optimizing system determines an optimal mode of inter-personal communication so rapidly that the determination of an optimal mode appears to be instantaneous.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

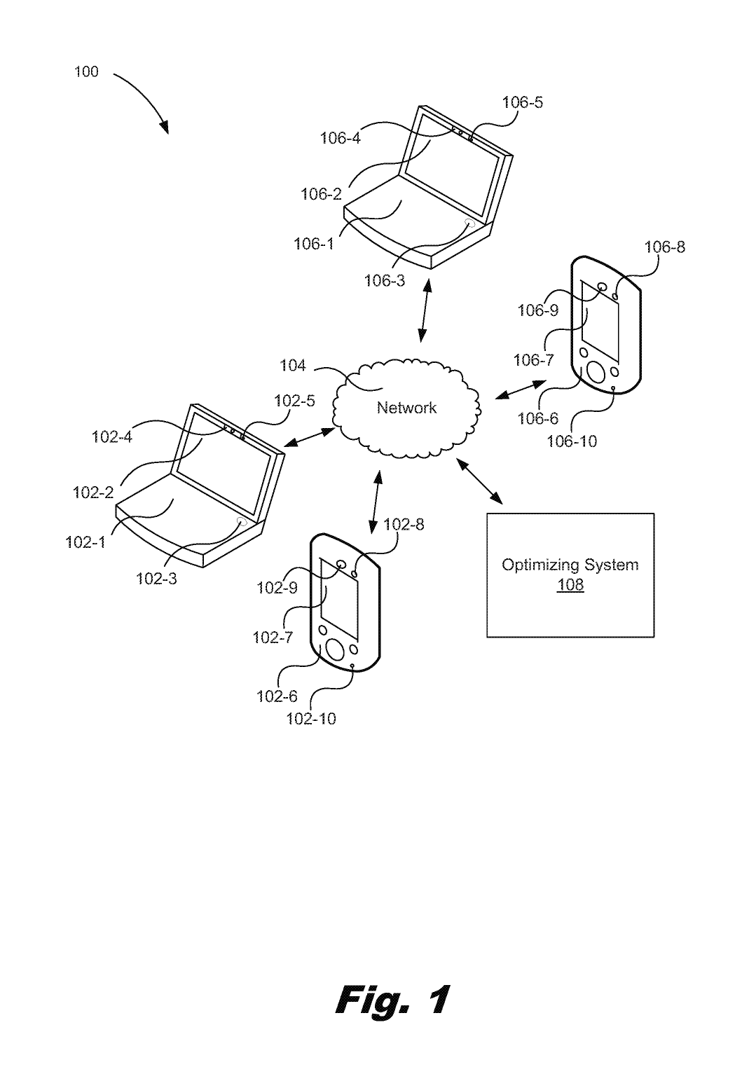

Referring now to the figures, FIG. 1 is a diagram of an example of a system (100) for optimizing a real-time inter-personal communication, according to the principles described herein. As will be described below, an optimizing system is in communication with a network to obtain user preferences for an inter-personal communication for an initiator and a recipient. The optimizing system receives an environmental context for the initiator and the recipient and determines an optimal mode of inter-personal communication in real-time between the initiator and the recipient based on a correlation of the user preferences and the environmental context. As a result, a mutually convenient mode of inter-personal communication is employed which is optimized for both the initiator and the recipient.

In one example, the system (100) includes a number of initiator devices (102). In this example, the initiator devices (102) may include a computer (102-1) and a smart phone (102-6). Further, the computer (102-1) may include a display (102-2), an audio speaker (102-3), a video camera (102-4), a microphone (102-5), or combinations thereof. Further, the smart phone (102-6) may include a display (102-7), an audio speaker (102-8), a video camera (102-9), a microphone (102-10), or combinations thereof. In this example, the computer (102-1) and the smart phone (102-6) have a number of modes for inter-personal communication. For example, the computer (102-1) may have a text based mode for inter-personal communication such as email, instant messaging services, social networking mechanisms, or combinations thereof. In this example, the display (102-2) on the computer (102-1) displays the content of the text based mode for inter-personal communication that the initiator desires to send to a recipient. Further, the computer (102-1) may have an audio based mode and video based mode for inter-personal communication such as video conference calling. In this example, the video camera (102-4) and the microphone (102-5) capture the content of the video based mode and the audio based mode, respectively, for inter-personal communication that the initiator desires to send to a recipient. Further, the display (102-2) on the computer (102-1) displays the content of the video based mode for inter-personal communication that the initiator desires to send to a recipient. Still further, the computer (102-1) may be used for an audio based mode for inter-personal communication. In this example, the audio speaker (102-3) may be used for the audio based mode for inter-personal communication.

Similarly, the smart phone (102-6) may have a text based mode for inter-personal communication such as email, instant messaging services, social networking mechanisms, or combinations thereof. In this example, the display (102-7) on the smart phone (102-6) displays the content of the text based mode for inter-personal communication that the initiator desires to send to a recipient. Further, the smart phone (102-6) may have an audio based mode and video based mode for inter-personal communication such as video conference calling. In this example, the video camera (102-9) and the microphone (102-10) capture the content of the video based mode and the audio based mode, respectively, for inter-personal communication that the initiator desires to send to a recipient. Further, the display (102-7) on the smart phone (102-6) displays the content of the video based mode for inter-personal communication that the initiator desires to send to a recipient. Further, the smart phone (102-6) may be used for an audio based mode for inter-personal communication. In this example, the audio speaker (102-8) may be used for the audio based mode for inter-personal communication.

In keeping with the given example, system (100) includes a number of recipient devices (106). In this example, the recipient devices (106) may include a computer (106-1) and a smart phone (106-6). Further, the computer (106-1) may include a display (106-2), an audio speaker (106-3), a video camera (106-4), a microphone (106-5), or combinations thereof. Further, the smart phone (106-6) may include a display (106-7), an audio speaker (106-8), a video camera (106-9), a microphone (106-10), or combinations thereof. In this example, the computer (106-1) and the smart phone (106-6) have a number of modes for inter-personal communication. For example, the computer (106-1) may have a text based mode for inter-personal communication such as email, instant messaging services, or combinations thereof. In this example, the display (106-2) on the computer (106-1) displays the content of the text based mode for inter-personal communication between the initiator and the recipient. Further, the computer (106-1) may have an audio based mode and video based mode for inter-personal communication such as video conference calling. In this example, the video camera (106-4) and the microphone (106-5) capture the content of the video based mode and the audio based mode, respectively, for inter-personal communication for the recipient. Further, the display (106-2) on the computer (106-1) displays the content of the video based mode for inter-personal communication between the initiator and recipient. Still further, the computer (106-1) may be used for an audio based mode for inter-personal communication. In this example, the audio speaker (106-3) may be used for the audio based mode for inter-personal communication.

Similarly, the smart phone (106-6) may have a text based mode for inter-personal communication such as email, instant messaging services, social networking mechanisms, or combinations thereof. In this example, the display (106-7) on the smart phone (106-6) displays the content of the text based mode for inter-personal communication that the initiator desires to send to a recipient. Further, the smart phone (106-6) may have an audio based mode and video based mode for inter-personal communication such as video conference calling. In this example, the video camera (106-9) and the microphone (106-10) capture the content of the video based mode and the audio based mode, respectively, for inter-personal communication for the recipient. Further, the display (106-7) on the smart phone (106-6) displays the content of the video based mode for inter-personal communication between the initiator and the recipient. Further, the smart phone (106-6) may be used for an audio based mode for inter-personal communication. In this example, the audio speaker (106-8) may be used for the audio based mode for inter-personal communication.

The system (100) further includes an optimizing system (108). In one example, the optimizing system (108) obtains user preferences for an inter-personal communication for an initiator and a recipient. As will be described in other parts of this specification, the user preferences include rules defining a mode of inter-personal communication for the initiator, the recipient, or combinations thereof. In one example, the rules may include a time, a location, a group, or combinations thereof that a mode may be used for an inter-personal communication between an initiator and a recipient.

The optimizing system (108) further receives an environmental context for the initiator and the recipient. As will be described in other parts of this specification, the environmental context may be the physical environment that the initiator, the recipient, or combinations thereof may be in. In one example, the environmental context includes networks, services, and modes of inter-personal communication available to the recipient and the initiator at a specific time, a location of the recipient and the initiator, or combinations thereof.

The optimizing system (108) further determines an optimal mode of inter-personal communication in real-time between the initiator and the recipient based on a correlation of the user preferences and the environmental context. The optimizing system (108) allows communication between the initiator and the recipient of inter-personal communications to reflect individual preferences and the environmental context of the initiator and the recipient such that the mode of inter-personal communication is optimal for both the initiator and the recipient. As a result, a mutually convenient mode of inter-personal communication is employed which is optimized for both the initiator and the recipient. More information about the optimizing system (108) will be described in detail in later parts of this specification.

Examples of the system (100) will now be described with reference to FIG. 1. In the examples below, an initiator, using one of the initiator devices (102), desires to initiate an inter-personal communication with a recipient who uses one of the recipient devices (106). In this example, the initiator initiates an inter-personal communication with a recipient by pressing a “contact” button, or other such mechanism, on one of the initiator devices (102) to initiate an inter-personal communication with the recipient who uses one of the recipient devices (106).

In one example, it is Monday at 1.00 pm and the initiator and the recipient are in their respective homes in San Francisco and connected via wireless fidelity (Wi-Fi). After the initiator presses “contact” on the smart phone (102-4), the optimizing system (108) determines that both the initiator and the recipient have Wi-Fi enabled connections, both the initiator and the recipient have a user preference for video based inter-personal communication, and the recipient is using a computer (106-1). The optimizing system (108) establishes a video based mode of communication, such as a video conference, between the initiator and the recipient for their inter-personal communication. In one example, the optimizing system (108) informs the initiator and the recipient that the video conference is about to commence. In this example, the video conference for the inter-personal communication uses the smart phone (102-4) and the computer (106-1).

In another example, it is Tuesday and while the initiator is still in San Francisco, the recipient is on a trans-oceanic flight to Hong Kong. After the initiator presses “contact”, the optimizing system (108) determines that the recipient is connected to the Internet via in-flight Wi-Fi with little bandwidth. The optimizing system (108) determines that the optimal mode for inter-personal communication is a text based mode such as instant messaging using a social media website. In this example, the optimizing system (108), determines that the instant messaging using the social media website is the optimal mode because there is no global system for mobile communication (GSM) connectivity for short message service (SMS) based messaging and because the recipient is active on the social media website at the present moment. As a result, the optimizing system (108) establishes a social media website instant messaging dialog between the initiator and the recipient. In this example, the optimizing system (108) displays a brief informational message on the computer (102-1) and the smart phone (106-4) explaining why this mode of inter-personal communication was selected to the initiator and the recipient.

In yet another example, it is Wednesday and the initiator has flown to Paris while the recipient is now in Hong Kong. The initiator is connected over a third generation (3G) connection while the recipient has a Wi-Fi connection. In this example, when the initiator presses “contact”, the optimizing system (108) determines an audio call through an audio conferencing service is the optimal mode of inter-personal communicating because the roaming charges for a normal telephone call for both the initiator and the recipient would exceed the data charges that the initiator incurs making the telephone call. In this example, the audio call for the inter-personal communication uses the smart phone (102-4) and the computer (106-1).

In still another example, it is Thursday and the initiator has confused his time zones and presses “contact” to initiate an inter-personal communication with the recipient. The optimizing system (108) receives the recipient environmental context and determines that the recipient should be asleep in Hong Kong. In this example, the initiator is given the opportunity to send an email to the recipient after the optimizing system (108) informs the initiator that it is night time where the recipient is and the recipient is not active on any devices. As a result, an optimal mode of inter-personal communication may be text based mode. In this example, the text based mode for the inter-personal communication uses the smart phone (102-4) and the computer (106-1).

In yet another example, it is Friday and the recipient is driving to the airport in Hong Kong. The initiator is sending the recipient an email using the computer (102-1) with the urgent flag set. As the message is sent, the optimizing system (108) detects that the recipient is not active on any email and is currently mobile. Given that the message is marked urgent, the optimizing system (108) determines the optimal mode of inter-personal communication is to convert the content of the email to audio and send the voice-message over the phone system to the recipient's smart phone (106-4). In this example, the recipient answers the smart phone (106-3) and receives the urgent message.

While this example has been described with reference to the optimizing system being located over the network, the optimizing system may be located in any appropriate location according to the principles described herein. For example, the optimizing system may be located in an initiator's device, a recipient's device, or combinations thereof.

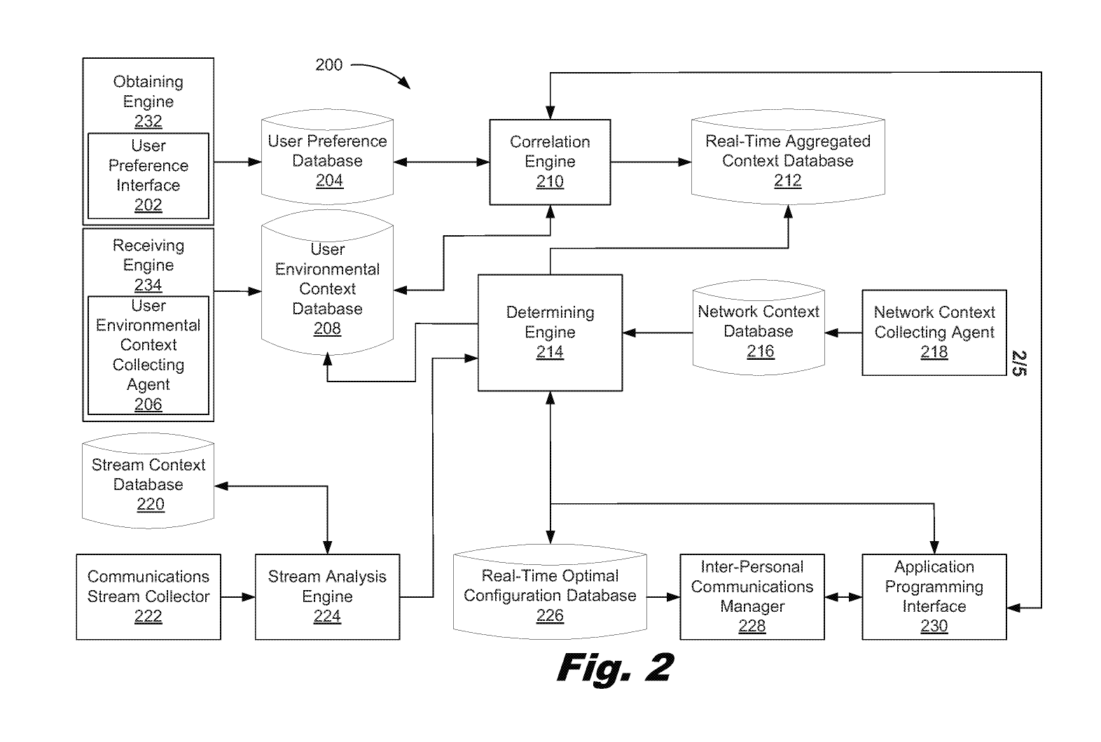

FIG. 2 is a diagram of an example of an optimizing system (200), according to the principles described herein. As mentioned above, the optimizing system (200) obtains user preferences for an inter-personal communication for an initiator and a recipient. Further, the optimizing system (200) receives an environmental context for the initiator and the recipient. Finally, the optimizing system (200) determines an optimal mode of inter-personal communication in real-time between the initiator and the recipient based on a correlation of the user preferences and the environmental context. As a result, a mutually convenient mode of inter-personal communication is employed which is optimized for both the initiator and the recipient.

In the example of FIG. 2, the system (200) includes an obtaining engine (232). In one example, the obtaining engine (232) uses a user preferences interface (202) to obtain user preferences for an inter-personal communication for an initiator and a recipient. In one example, the user preferences interface (202) allows an initiator and a recipient to record user preferences for modes of inter-personal communication. As mentioned above, the user preferences include rules defining a mode of inter-personal communication for the initiator, the recipient, or combinations thereof. In one example, the rules may include a time, a location, a group, or combinations thereof that a mode may be used for an inter-personal communication between an initiator and a recipient. For example, a rule for a user preference may be use phone connection if no other form of voice communication is possible. In another example, a rule for a user preference may exclusively allow connections from work colleagues to work-owned devices. In yet another, a rule for a user preference may be after 5:30 pm exclusively accept text based communications from work colleagues.

Further, the user preferences are stored and maintained in the user preference database (204). In this example, the user preference database (204) may store and maintain user preference for an initiator and user preference for a recipient.

The system (200) further includes a receiving engine (234). In one example, the receiving engine (234) receives an environmental context for the initiator and the recipient uses a user environmental context collecting agent (206). In one example, the user environmental context collecting agent (206) monitors the environmental context of the initiator and recipient. In this example, the user environmental context collecting agent (206) monitors the environmental context of the initiator and recipient in real-time. As mentioned above, the environmental context may be the physical environment that the initiator, the recipient, or combinations thereof may be in. In one example, the environmental context includes networks, services, modes of inter-personal communication available to the recipient and the initiator at a specific time, a location of the recipient and the initiator, or combinations thereof.

In one example, the user environmental context collecting agent (206) monitors the environmental context of the initiator and recipient and stores the environmental context of the initiator and recipient in a user environmental context database (208) which stores and maintains the environmental context information.

As mentioned above, the optimizing system (200) determines an optimal mode of inter-personal communication in real-time between the initiator and the recipient based on a correlation of the user preferences and the environmental context. In one example, a correlation engine (210) is used to determine the correlation of the user preferences and the environmental context. In this example, the correlation engine (210) analyzes data in real-time from the user preferences database (204) and the user environmental context database (208) to determine a set of characteristics for the initiator and the recipient that describes the best mechanism for carrying out inter-personal communication with the initiator and the recipient at any given time. In one example, the set of characteristics produced by the correlation engine (210) are sent to a real-time aggregated context database (212). In this example, the real-time aggregated context database (212) stores the set of characteristics data produced by the correlation engine (210).

In keeping with the given example, the system (200) includes a network content collecting agent (218). In one example, the network content collecting agent (218) monitors characteristics of the networks or services available to an initiator and a recipient to which the initiator and the recipient may connect. In this example, a network context database (216) stores and maintains the network context characteristics produced by the network content collecting agent (218).

In conjunction with characteristics of the networks and services to which the initiator and the recipient may be able to exploit, such as quality, cost, reliability, or combinations thereof, a determining engine (214) determines an optimal mode of inter-personal communication in real-time between the initiator and the recipient based on a correlation of the user preferences and the environmental context. In one example, the determining engine (214) constructs a dynamically adjustable profile which determines the optimal mode for inter-personal communication between an initiator and a recipient. In this example, the dynamically adjustable profile is stored in the real-time optimal configuration database (226).

In one example, the real-time optimal configuration database (226) is subsequently used by the inter-personal communications manager (228) to define and establish parameters and modes of inter-personal communication between an initiator and a recipient. Further, information regarding the characteristics, rules or combinations thereof for inter-personal communication for an initiator and a recipient may also be fed directly into the user environmental context database (208) where appropriate.

The system (200) further includes a communications stream collector (222) and a stream context database (220). In one example, the communications stream collector (222) captures content from a stream of real time inter-personal communications between an initiator and a recipient. In one example, the stream context database (220) contains information regarding the contextual content of the real time inter-personal communications stream. In keeping with the given example, a stream analysis engine (224) performs an analysis of the real time inter-personal communications streams from the communications stream collector (222) and in conjunction with content from the stream context database (220). In one example, the output of the stream analysis engine (224) is fed directly into the determining engine (214). In another example, the output of the stream analysis engine (224) is fed back into the stream context database (220).

The system further includes an application programming interface (API) (230). In one example, the API allows any number of external systems or applications to consume information or control the functions of the system (200).

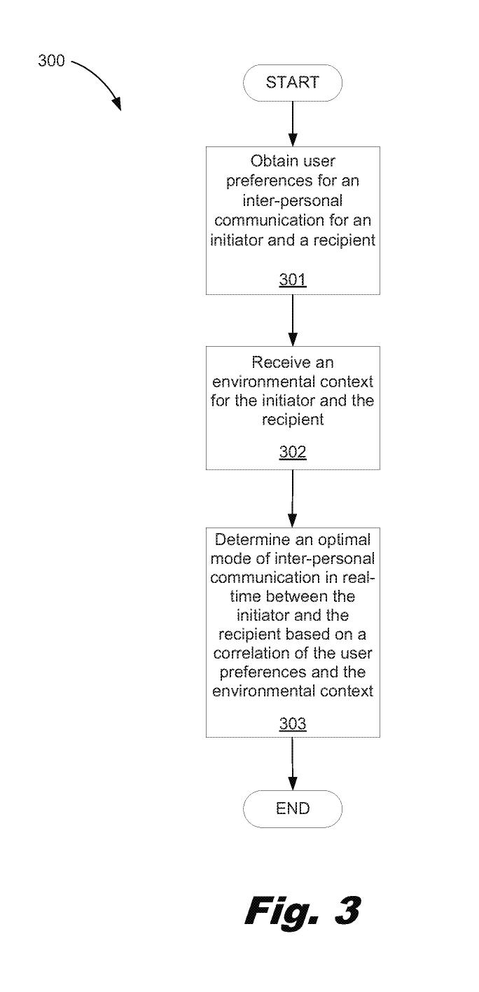

FIG. 3 is a flowchart of an example of a method for optimizing real-time inter-personal communications, according to one example of principles described herein. In this example, the method (300) includes obtaining (301) user preferences for an inter-personal communication for an initiator and a recipient, receiving (302) an environmental context for the initiator and the recipient, and determining (303) an optimal mode of inter-personal communication in real-time between the initiator and the recipient based on a correlation of the user preferences and the environmental context.

As mentioned above, the method (300) includes obtaining (301) user preferences for an inter-personal communication for an initiator and a recipient. As mentioned above, there are many different modes of inter-personal communication that exist for inter-personal communications. As mentioned above, such modes include a text based mode, an audio based mode, a video based mode, or combinations thereof.

In one example, an obtaining engine may be used to obtain user preferences for an inter-personal communication for an initiator and a recipient. Further, the obtaining engine may include a user preferences interface. In one example, the user preferences interface allows an initiator and a recipient to record user preferences for modes of inter-personal communication. As mentioned above, the user preferences include rules defining a mode of inter-personal communication for the initiator, the recipient, or combinations thereof. In one example, the rules may include a time, a location, a group, or combinations thereof that a mode may be used for an inter-personal communication between an initiator and a recipient. For example, a rule for a user preference may use phone connection if no other form of voice communication is possible. In another example, a rule for a user preference may exclusively allow connections from work colleagues to work-owned devices. In yet another, a rule for a user preference may be after 5:30 pm exclusively accept text based communications from work colleagues.

Further, the user preferences are stored and maintained in the user preference database. In this example, the user preference database may store and maintain user preference for an initiator and user preference for a recipient.

As mentioned above, the method (300) includes receiving (302) an environmental context for the initiator and the recipient. In one example, a receiving engine may be used to receive an environmental context for the initiator and the recipient. In one example, the receiving engine uses a user environmental context collecting agent to monitor the environmental context of the initiator and recipient. In this example, the user environmental context collecting agent monitors the environmental context of the initiator and recipient in real-time. As mentioned above, the environmental context may be the physical environment that the initiator, the recipient, or combinations thereof may be in. In one example, the environmental context includes networks, services, modes of inter-personal communication available to the recipient and the initiator at a specific time, a location of the recipient and the initiator, or combinations thereof. For example, the method (300) may determine whether the recipient or the initiator is stationary or moving, whether the recipient or the initiator is in a car, whether the recipient or the initiator is active on a particular service, or combinations thereof.

In one example, the user environmental context collecting agent monitors the environmental context of the initiator and recipient and stores the environmental context of the initiator and recipient in a user environmental context database (208) which stores and maintains the environmental context information.

As mentioned above, the method (300) includes determining (303) an optimal mode of inter-personal communication in real-time between the initiator and the recipient based on a correlation of the user preferences and the environmental context. In one example, a correlation engine is used to determine the correlation of the user preferences and the environmental context. In this example, the correlation engine analyzes data in real-time from the user preferences database and the user environmental context database to determine a set of characteristics for an initiator and a recipient that describes the best mechanism for carrying out inter-personal communication with the initiator and the recipient at any given time. In one example, the set of characteristics produced by the correlation engine are sent to a real-time aggregated context database. In this example, the real-time aggregated context database stores the set of characteristics data produced by the correlation engine. As a result, the correlation engine combines individual preferences information with individual environmental context to establish a snapshot of an individual's inter-personal communications preferences and capabilities at any given moment. Thus, an optimal mode of inter-personal communication in real-time between the initiator and the recipient based on a correlation of the user preferences and the environmental context is determined.

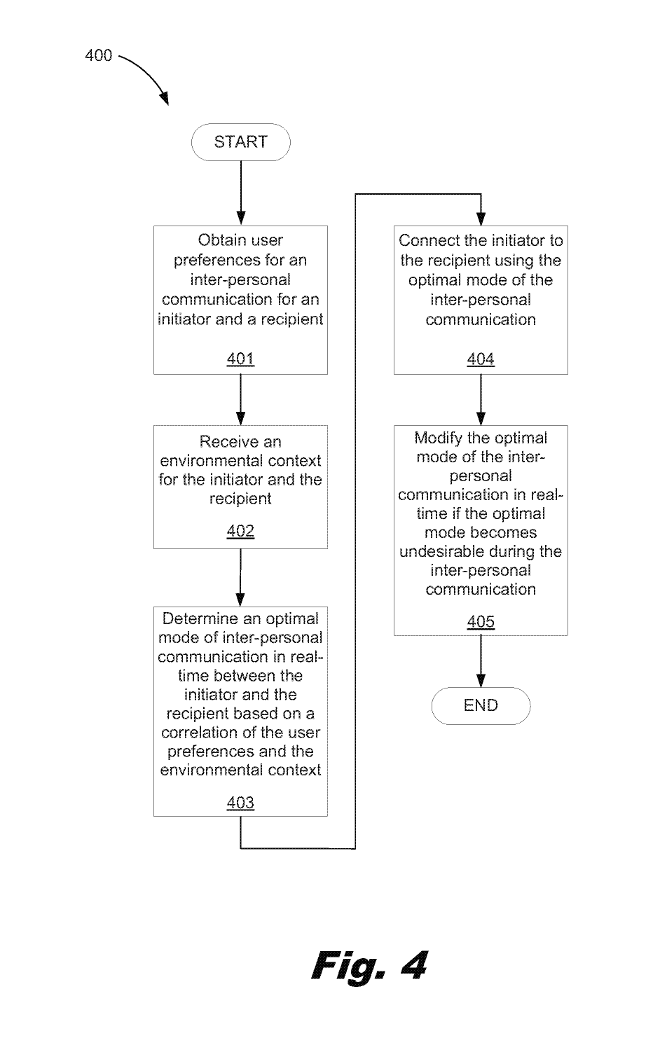

FIG. 4 is a flowchart of an example of a method for optimizing a real-time inter-personal communication, according to one example of principles described herein. In this example, the method (400) includes obtaining (401) user preferences for an inter-personal communication for an initiator and a recipient, receiving (402) an environmental context for the initiator and the recipient, determining (403) an optimal mode of inter-personal communication in real-time between the initiator and the recipient based on a correlation of the user preferences and the environmental context, connecting (404) the initiator to the recipient using the optimal mode of the inter-personal communication, and modifying (405) the optimal mode of the inter-personal communication in real-time if the optimal mode becomes undesirable during the inter-personal communication.

As mentioned above, the method (400) includes connecting (404) the initiator to the recipient using the optimal mode of the inter-personal communication. In one example, the optimal mode may be text based mode, audio based mode, video based mode, or combinations thereof. Further, the optimal mode may connect an initiator using one type of initiator device with a recipient using another type of recipient device. For example, a smart phone may be used by the initiator to initiate the inter-personal communication and a computer may be used by the recipient to receive the inter-personal communication from the initiator.

As mentioned above, the method (400) includes modifying (405) the optimal mode of the inter-persona communication in real-time if the optimal mode becomes undesirable during the inter-personal communication. For example, an inter-personal communication may commence via a telephone call with the initiator and the recipient connected to Wi-Fi network. In this example, if the optimizing system determines the optimal mode becomes undesirable during the inter-personal communication, the optimal mode of inter-personal communication may be switch to, for example, a video based mode.

In another example, an inter-personal communication may be ongoing over a public service such as social media website. If the inter-personal communications contained company sensitive information, then the inter-personal communication is detected by the stream analysis engine of FIG. 2 and the inter-personal communication is transposed to a more appropriate mode of inter-personal communication. Further, the stream analysis engine of FIG. 2 may update the stream context database of FIG. 2 as a result of the analysis of the inter-personal communication.

FIG. 5 is a diagram of an example of an optimizing system (500) according to the principles described herein. The optimizing system (500) includes an obtaining engine (502), a receiving engine (504), a determining engine (506), and a correlation engine (508). In this example, the optimizing system (500) also includes a connecting engine (510) and a modifying engine (512). The engines (502, 504, 506, 508, 510, 512) refer to a combination of hardware and program instructions to perform a designated function. Each of the engines (502, 504, 506, 508, 510, 512) may include a processor and memory. The program instructions are stored in the memory and cause the processor to execute the designated function of the engine.

The obtaining engine (502) obtains user preferences for an inter-personal communication for an initiator and a recipient. In one example, the obtaining engine (502) obtains user preferences for an inter-personal communication for an initiator and not the recipient. In another example, the obtaining engine (502) obtains user preferences for an inter-personal communication for a recipient and not the initiator. In yet another example, the obtaining engine (502) obtains user preferences for an inter-personal communication for both an initiator and a recipient.

The receiving engine (504) receives an environmental context for the initiator and the recipient. In one example, the receiving engine (504) receives an environmental context for the initiator and not the recipient. In another example, the receiving engine (504) receives an environmental context for the recipient and not the initiator. In yet another example, the receiving engine (504) receives an environmental context for both the initiator and the recipient.

The determining engine (506) determines an optimal mode of inter-personal communication in real-time between the initiator and the recipient based on a correlation of the user preferences and the environmental context. In one example, the optimal mode of the inter-personal communication may include a text based mode, an audio based mode, a video based mode, or combinations thereof.

The correlation engine (508) correlates the user preferences with the environmental context to further determine an optimal mode of inter-personal communication in real-time between the initiator and the recipient. In one example, the correlation engine (508) correlates the user preferences with the environmental context for the recipient. In another example, the correlation engine (508) correlates the user preferences with the environmental context for the initiator. In yet another example, the correlation engine (508) correlates the user preferences with the environmental context for both the initiator and the recipient.

The connecting engine (510) connects the initiator to the recipient using the optimal mode of the inter-personal communication. In one example, the optimal mode of the inter-personal communication may include a text based mode, an audio based mode, a video based mode, or combinations thereof.

The modifying engine (512) modifies the optimal mode of the inter-personal communication in real-time if the optimal mode becomes undesirable during the inter-personal communication. In one example, the modifying engine (510) modifies the optimal mode of the inter-personal communication to a text based mode, an audio based mode, a video based mode, or combinations thereof.

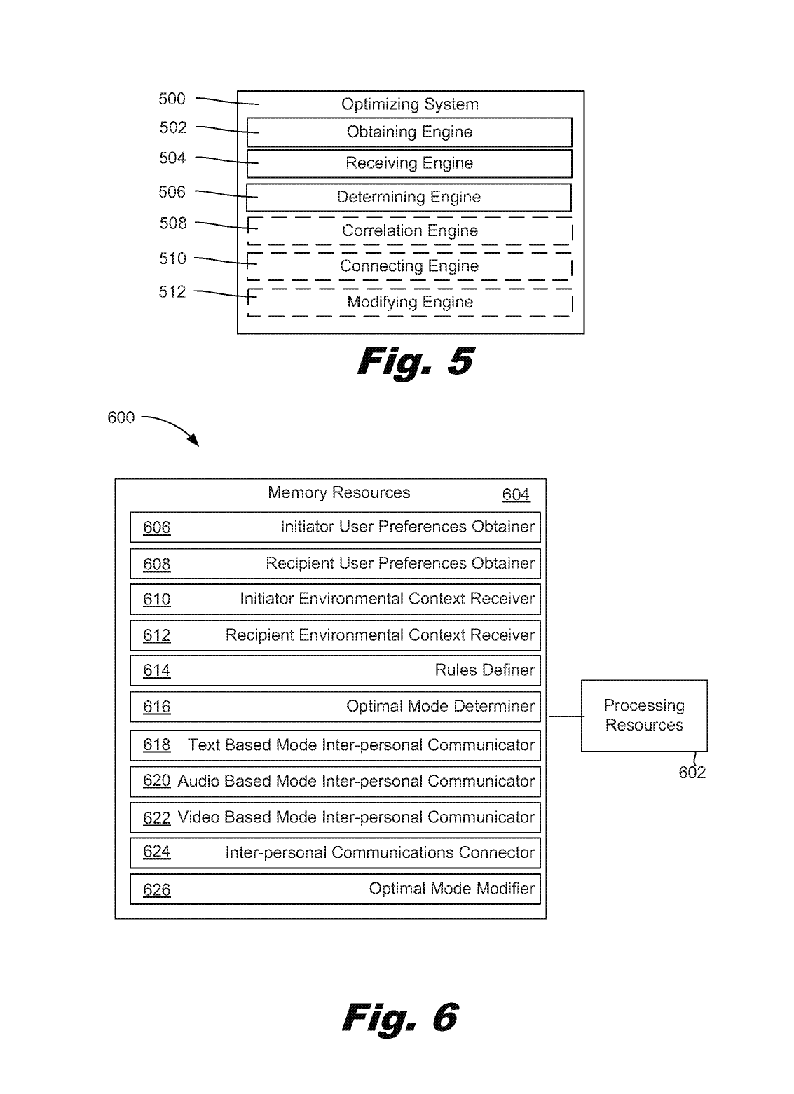

FIG. 6 is a diagram of an example of an optimizing system (600) according to the principles described herein. In this example, optimizing system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the optimizing system (600). The programmed instructions shown stored in the memory resources (604) include an initiator user preferences obtainer (606), a recipient user preferences obtainer (608), an initiator environmental context receiver (610), a recipient environmental context receiver (612), a rules definer (614), an optimal mode determiner (616), a text based mode inter-personal communicator (618), an audio based mode inter-personal communicator (620), a video based mode inter-personal communicator (622), an inter-personal communications connector (624), and an optimal mode modifier (626).

The memory resources (604) include a computer readable storage medium that contains computer readable program code to cause tasks to be executed by the processing resources (602). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The initiator user preferences obtainer (606) represents programmed instructions that, when executed, cause the processing resources (602) to obtain user preferences for the initiator. The recipient user preferences obtainer (608) represents programmed instructions that, when executed, cause the processing resources (602) to obtain user preferences for the recipient. The initiator environmental context receiver (610) represents programmed instructions that, when executed, cause the processing resources (602) to receive an environmental context for the initiator. The recipient environmental context receiver (612) represents programmed instructions that, when executed, cause the processing resources (602) to receive an environmental context for the recipient.

The rules definer (614) represents programmed instructions that, when executed, cause the processing resources (602) to define rules for the initiator and the recipient. The optimal mode determiner (614), represents programmed instructions that, when executed, cause the processing resources (602) to determine an optimal mode for an inter-personal communication.

The text based mode inter-personal communicator (618) represents programmed instructions that, when executed, cause the processing resources (602) to communicate using a text based mode inter-personal communication if the text based mode is the optimal mode. The audio based mode inter-personal communicator (620) represents programmed instructions that, when executed, cause the processing resources (602) to communicate using an audio based mode inter-personal communication if the audio based mode is an optimal mode. The video based mode inter-personal communicator (622) represents programmed instructions that, when executed, cause the processing resources (602) to communicate using a video based mode inter-personal communication if the video based mode is an optimal mode.

The inter-personal communications connector (624) represents programmed instructions that, when executed, cause the processing resources (602) to connect the initiator and the recipient for an inter-personal communication. The optimal mode modifier (626) represents programmed instructions that, when executed, cause the processing resources (602) to modify the optimal mode of communication for the inter-personal communication in real-time if the optimal mode becomes undesirable during the inter-personal communication.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs. CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (602) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the optimizing system (600) may be implemented on a user device, on a server, on a collection of servers, or combinations thereof.

The optimizing system (600) of FIG. 6 may be part of a general purpose computer. However, in alternative examples, the optimizing system (600) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for real-time inter-personal communication, the method comprising:
obtaining user preferences for an inter-personal communication for an initiator and a recipient;
receiving an environmental context for the initiator and the recipient; and
determining an optimal mode of inter-personal communication in real-time between the initiator and the recipient based on a correlation of the user preferences and the environmental context.

2. The method of claim 1, in which the user preferences comprises rules defining a mode of the inter-personal communication for the initiator, the recipient, or combinations thereof.

3. The method of claim 2, in which the rules comprise a time, a group, a location, or combinations thereof that the mode may be used for the inter-personal communication.

4. The method of claim 2, in which the mode of the inter-personal communication comprises a text based mode, an audio based mode, a video based mode, or combinations thereof.

5. The method of claim 1, in which the environmental context comprises networks, services, modes of inter-personal communication available to the recipient and the initiator at a specific time, a location of the recipient and the initiator, or combinations thereof.

6. The method of claim 1, further comprising modifying the optimal mode of the inter-personal communication in real-time if the optimal mode becomes undesirable during the inter-personal communication.

7. The method of claim 1, further comprising connecting the initiator to the recipient using the optimal mode of the inter-personal communication.

8. A system for optimizing a real-time inter-personal communication, the system comprising:
an obtaining engine to obtain user preferences for an inter-personal communication for an initiator and a recipient;
a receiving engine to receive an environmental context for the initiator and the recipient;
a correlation engine to correlate the user preferences for the initiator and the recipient with the environmental context for the initiator and the recipient;
a determining engine to determine an optimal mode of inter-personal communication in real-time between the initiator and the recipient based on a correlation of the user preferences and the environmental context; and
a modifying engine to modify the optimal mode of the inter-personal communication in real-time if the optimal mode becomes undesirable during the inter-personal communication.

9. The system of claim 8, in which the user preferences comprises rules defining a mode of the inter-personal communication for the initiator, the recipient, or combinations thereof and in which the rules comprise a time, a group, a location, or combinations thereof that the mode may be used for the inter-personal communication.

10. The system of claim 8, in which the mode of the inter-personal communication comprises a text based mode, an audio based mode, a video based mode, or combinations thereof.

11. The system of claim 8, in which the environmental context comprises networks, services, modes of inter-personal communication available to the recipient and the initiator at a specific time, a location of the recipient and the initiator, or combinations thereof.

12. The system of claim 8, further comprising a connecting engine to connect the initiator to the recipient using the optimal mode of the inter-personal communication.

13. A computer program product for optimizing a real-time inter-personal communication, comprising:
a tangible computer readable storage medium, the tangible computer readable storage medium comprising computer readable program code embodied therewith, the computer readable program code comprising program instructions that, when executed, causes a processor to:
determine an optimal mode of an inter-personal communication in real-time between an initiator and an recipient based on a correlation of user preferences and an environmental context; and
modify the optimal mode of the inter-personal communication in real-time if the optimal mode becomes undesirable during the inter-personal communication.

14. The product of claim 13, further comprising computer readable program code comprising program instructions that, when executed, cause the processor to obtain the user preferences for the inter-personal communication for the initiator and the recipient.

15. The product of claim 13, further comprising computer readable program code comprising program instructions that, when executed, cause the processor to receive the environmental context for the initiator and the recipient.
